(19) United States
(12) Patent Application Publication
(10) Pub. No.: US 2024/0268363 A1
(43) Pub. Date: Aug. 15, 2024

(54) Golf Cart Fishing Pole Holder

(71) Applicant: Robert St. John, Saint Augustine, FL (US)

(72) Inventor: Robert St. John, Saint Augustine, FL (US)

(21) Appl. No.: 18/642,069

(22) Filed: Apr. 22, 2024

Related U.S. Application Data
(63) Continuation-in-part of application No. 17/880,716, filed on Aug. 4, 2022, now Pat. No. 11,987,213.
(60) Provisional application No. 63/502,130, filed on May 15, 2023.

(51) Int. Cl. A01K 97/10; B60R 9/06; B60R 9/08

(52) U.S. Cl. CPC A01K 97/10; B60R 9/06; B60R 9/08

(57) ABSTRACT

A golf cart fishing pole holder is disclosed including a main frame with a front and rear lateral member connected to each other by two side members. One or two movable frames have side sections that are rotatably coupled to a respective one of the two side members by a pivot and have a plurality of tubular rod holders affixed thereto. Each of the movable frames rotate about each pivot between a first position in which the tubular rod holders are substantially perpendicular to side members and a second, locking position (e.g., using a pin) in which the tubular rod holders are at a non-zero angle with respect to the side members.

### FIELD OF THE INVENTION

This invention relates to the field of fishing and more particularly to a system for holding and organizing fishing poles in a golf cart.

### BACKGROUND OF THE INVENTION

Many people that fish (e.g., fishermen) have a large collection of fishing poles, often a dozen fishing poles or more. Each fishing pole and reel combination is typically unique and rigged for catching certain species of fish in certain environments.

As many people that fish often travel by vehicle to the location of fishing, many of these fishing poles need to be transported to that location. As there is often a large investment in each fishing pole and reel, it is important not to damage them during transit. Further, having so many fishing poles and reels, often pre-rigged, it is easy for neighboring fishing poles to become entangled, taking time when arriving at the fishing location to detangle a mess of fishing poles and riggings, as in the past, several fishing poles were often just placed in the back of a golf cart at the mercy of sharp turns and quick stops. Many communities require the use of golf carts for moving about in the communities or make it much more convenient to get around using a golf cart.

To help alleviate this problem, solutions of the past included fishing pole holders that bolt onto the golf cart. Bolting onto the golf cart is often undesirable because the golf cart is often used for other purposes and the mounted fishing pole holder will impede such other uses.

What is needed is a fishing pole holder that will remain stable while in a golf cart, will easily transfer between the golf cart and storage, and will allow use of the golf cart when not holding fishing poles.

### SUMMARY OF THE INVENTION

The present invention improves over the prior art by providing a golf cart fishing pole holder that has one or two rows of rod holders, each row of rod holders is held by a movable frame and each movable frame is interfaced to a main frame by pivots such that each row of rod holders has two positions. In the first position, the rod holders lay flat (e.g., for storage or for using the golf cart to carry other objects) and in a second position, the rod holders extend upwardly at an angle for holding a fishing pole in each. In some embodiments, the frame has handles for carrying the golf cart fishing pole holder. When the movable frame(s) is/are in the first position, the fishing pole holder is substantially flat, permitting the golf cart to be used for carrying other objects atop the golf cart fishing pole holder.

In one embodiment, a golf cart fishing pole holder is disclosed including a main frame that has a front lateral member and a rear lateral member connected to each other by two side members. The ends of each of the two side members connected to a respective front lateral member and rear lateral member at substantially right angles. A movable frame has two side sections, and each side section is rotatably coupled to a respective one of the two side members. The movable frame has a plurality of rod holders affixed thereto, each rod holder for accepting a fishing pole. The movable frame is rotatable between a first position in which the rod holders are within five degrees of being parallel to side members (e.g., relatively flat) and a second position in which the tubular rod holders are at a non-zero angle with respect to the side members (e.g., for holding fishing poles). In some embodiments, the golf cat fishing pole holder includes a deck that has one or more orifices cut or formed therein for securing accessories often used in fishing such as an orifice for a bucket, an orifice for a cooler, and/or an orifice for a tackle box.

In another embodiment, a method of holding fishing poles on a golf cart is disclosed. The method includes providing a fishing pole holder that has a main frame. The main frame has a front lateral member and a rear lateral member connected to each other by two side members such that ends of each of the two side members connected a respective front lateral member and rear lateral member at substantially right angles and the front lateral member and the rear lateral member sized to fit within a bed of the golf cart. The fishing pole holder also includes a movable frame. The movable frame has two side sections, and each side section is rotatably coupled to a respective one of the two side members; and the movable frame has a plurality of tubular rod holders affixed thereto. The method further includes placing the fishing pole holder onto the bed of the golf cart and rotating the movable frame to a position in which the tubular rod holders are at a non-zero angle with respect to the side members then placing the fishing poles in any of the tubular rod holders.

In another embodiment, an apparatus for holding fishing poles for a golf cart is disclosed. The apparatus includes a main frame that has a front lateral member and a rear lateral member connected to each other by two side members, ends of each of the two side members are connected respectively to a front lateral member and a rear lateral member at substantially right angles, the front lateral member and the rear lateral member sized to fit within a bed of a golf cart. The apparatus includes a movable frame that has two side sections connected by a connecting member and each side section is rotatably coupled to a respective one of the two side members by a pivot. A set of tubular rod holders are affixed to a surface of the connecting member, each tubular rod holder is for accepting a fishing pole. The movable frame is rotatable about each pivot between a first position in which the tubular rod holders are within five degrees of being parallel to side members and a second position in which the tubular rod holders are at a non-zero angle with respect to the side members. A hole passes through each of the side sections and the side member and the hole is sized to accept a locking pin.

### BRIEF DESCRIPTION OF DRAWINGS

The invention can be best understood by those having ordinary skill in the art by reference to the following detailed description when considered in conjunction with the accompanying drawings in which:

FIGS. 1-12 illustrate perspective views of a fishing pole holder from various angles and sides installed in a truck bed or stored on a different surface, other than the truck bed.

FIGS. 13-16 illustrate perspective views of a golf cart fishing pole holder from various angles and sides.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

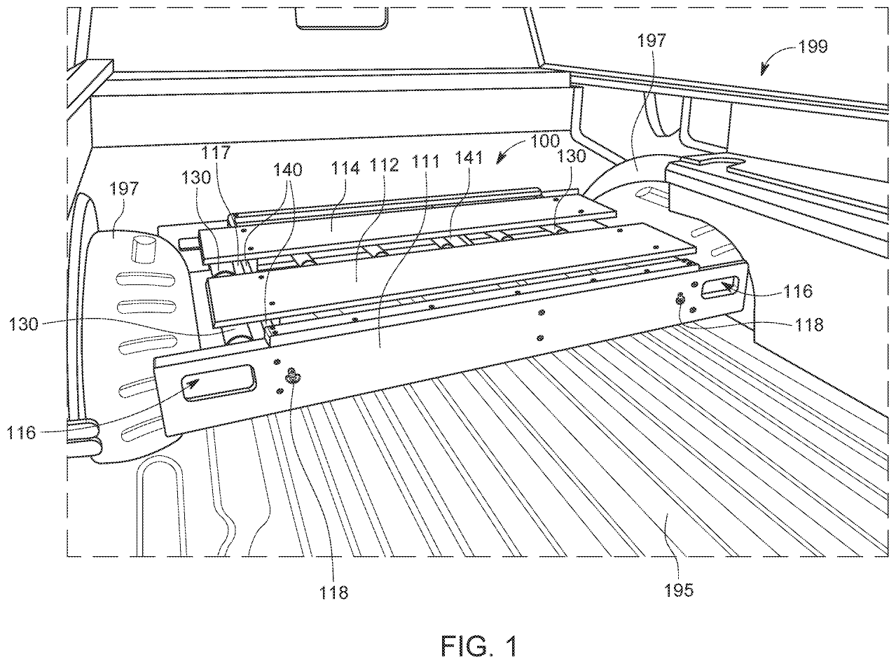

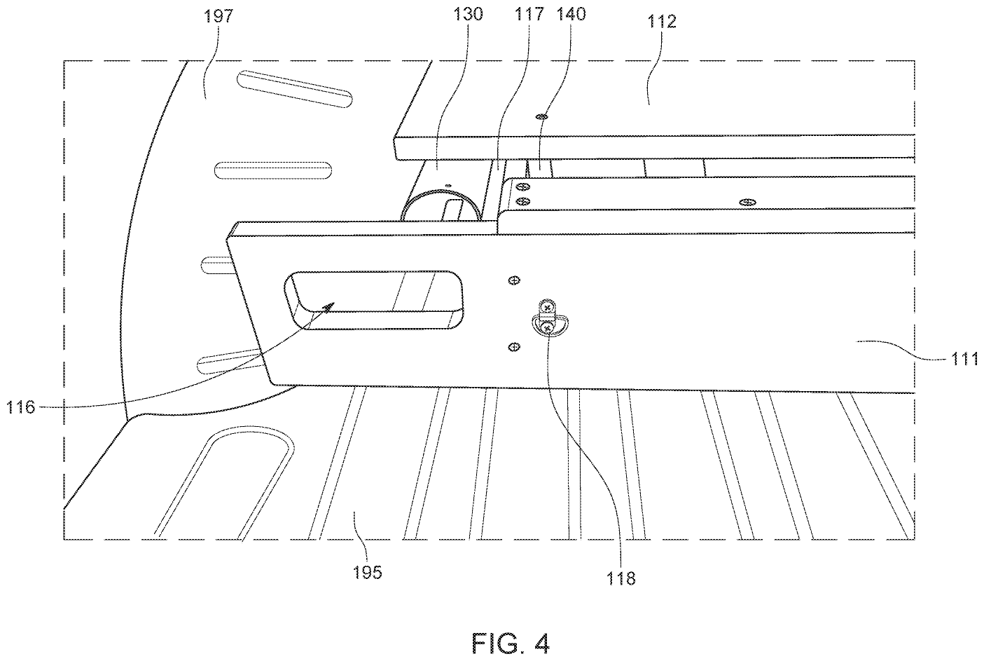

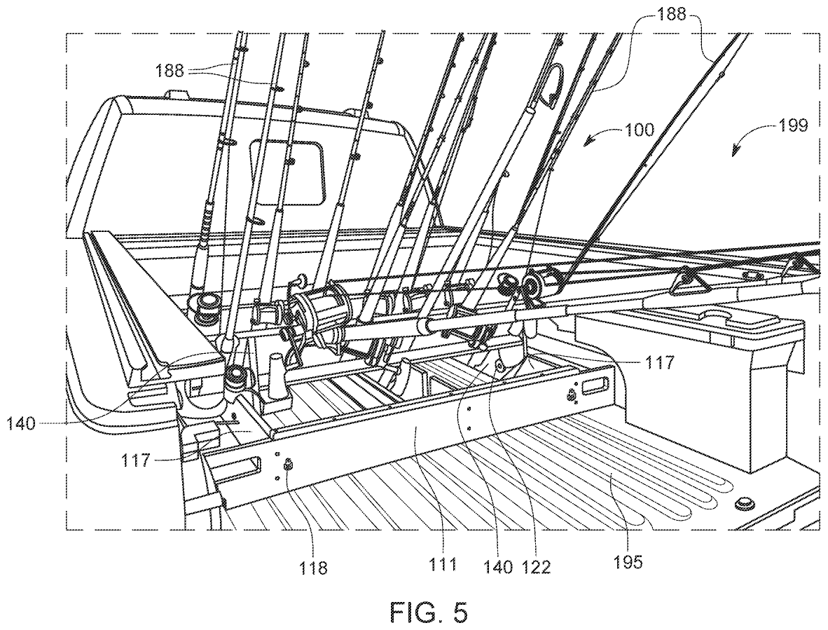

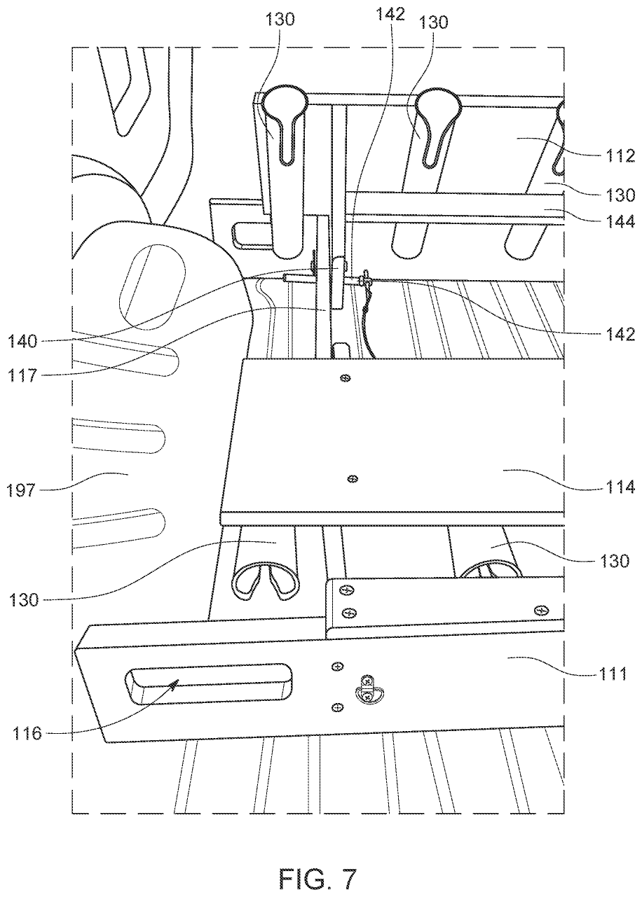

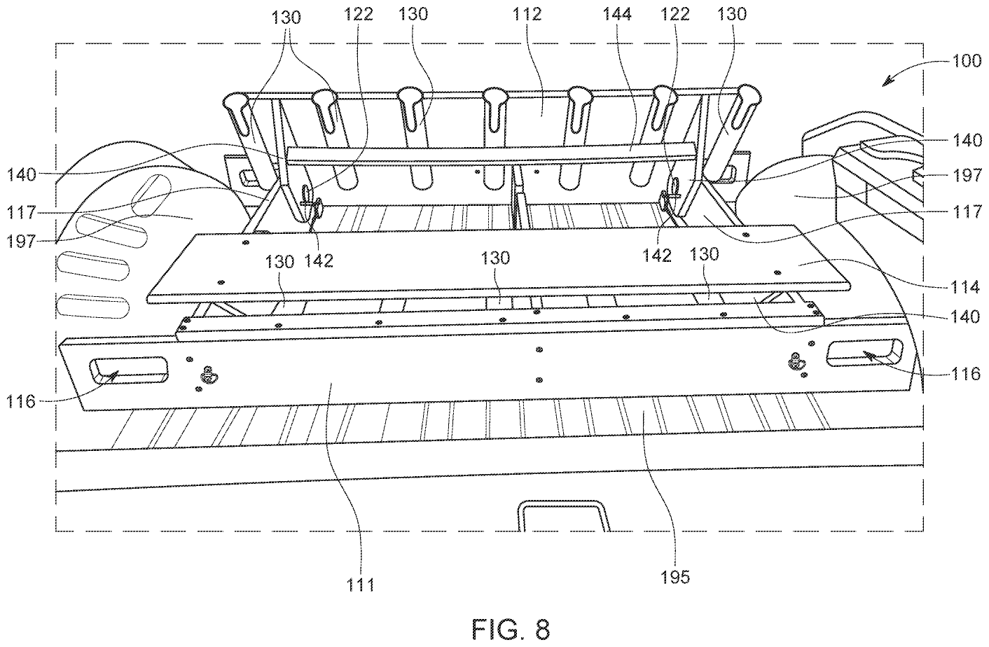

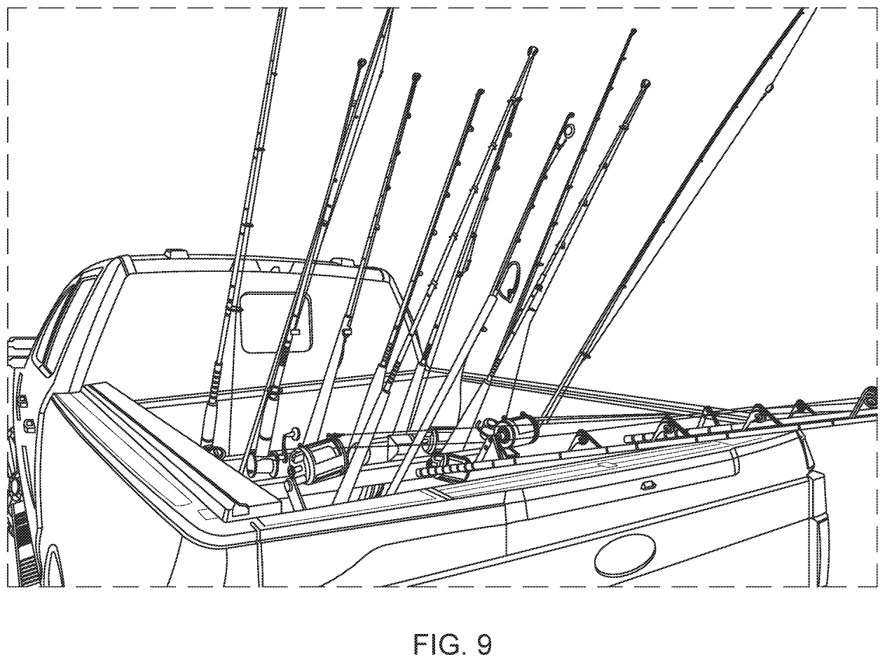

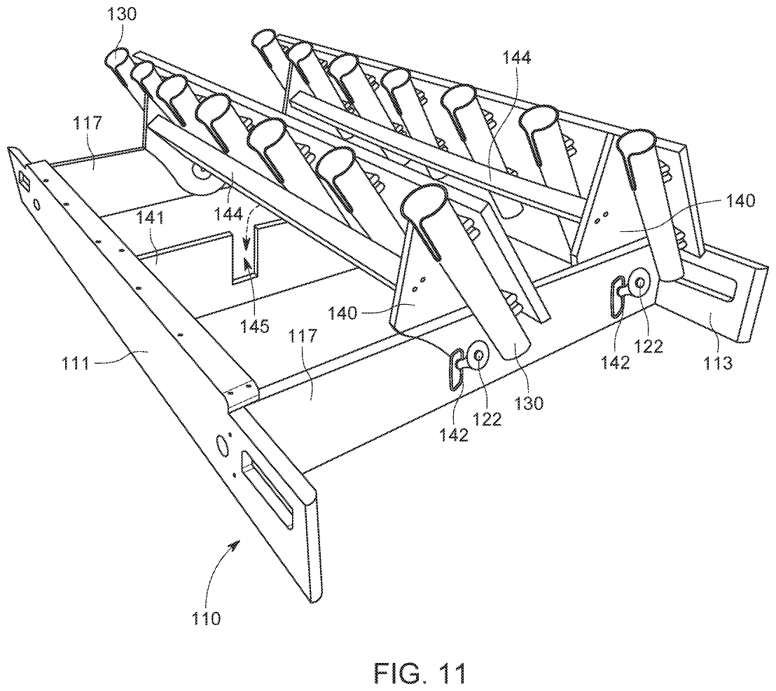

Although the fishing pole holder is shown being used in a pickup truck bed in FIGS. 1-12 with the frame legs straddling the wheel wells of the pickup truck bed, there are no limitations as to where the fishing pole holder is to be used. For example, it is anticipated that the fishing pole holder operate in a free-standing mode (e.g., resting on a road or driveway) for washing the fishing poles and reels with a water hose. Likewise, when in the first position in which the rod holders lay flat (e.g., absent of fishing poles), it is anticipated that the fishing pole holder will be stored in an upright orientation, for example against a garage wall.

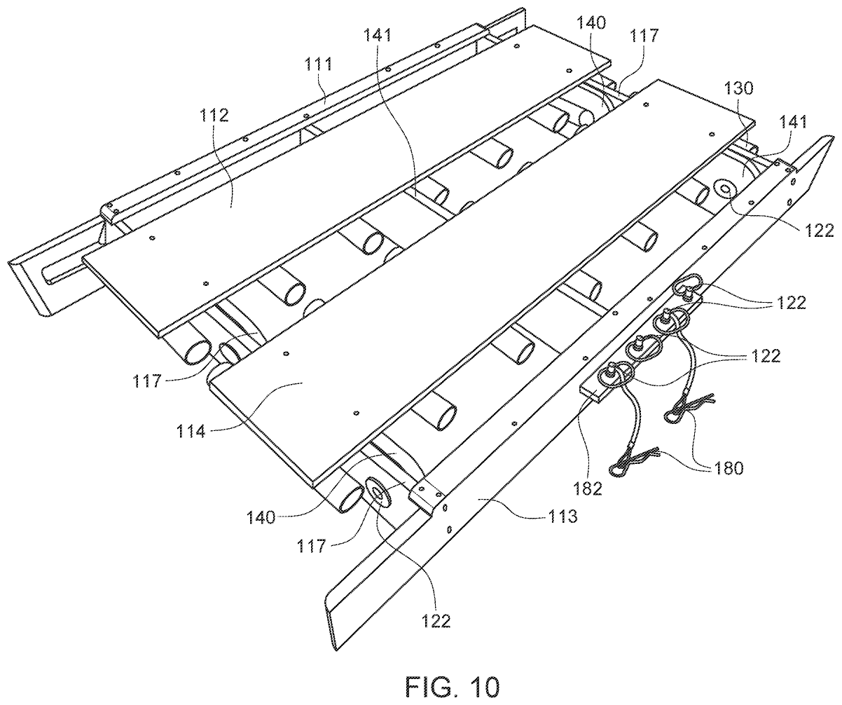

Referring to FIGS. 1-12, perspective views of a fishing pole holder 100 from various angles and sides are shown. In FIGS. 1-9, the fishing pole holder 100 is shown installed in on the floor 195 of a truck bed 199 while in FIGS. 10-12, the fishing pole holder 100 is shown external to the truck bed, for example, resting on a surface (e.g., a road surface or driveway).

In the embodiment shown, there are two rows of rod holders 130. One row of rod holders 130 are held by a first movable frame 112 and a second row of rod holders 130 are held by a second movable frame 114. Each movable frame 112/114 includes a side section 140 and optionally an optional central support member 141. The side section 140 of each movable frame 112/114 is interfaced to a main frame 110 by pivots 122 such that each movable frame 112/114 has two positions that are independent of each other. In a first position, the respective movable frame 112/114 lays flat with respect to the main frame 110 (e.g., for storage). In the second position, each movable frame 112/114 extends upwardly at an angle from the main frame 110, allowing for a fishing pole 188 to be inserted in each rod holder 130. A pin 142 is provided to pass through a hole 143 that is bored through a side section 140 of each movable frame 112/114 and through a side member 117 of the main frame 110 to hold/lock the movable frame 112/114 in the desired position with respect to the main frame 110.

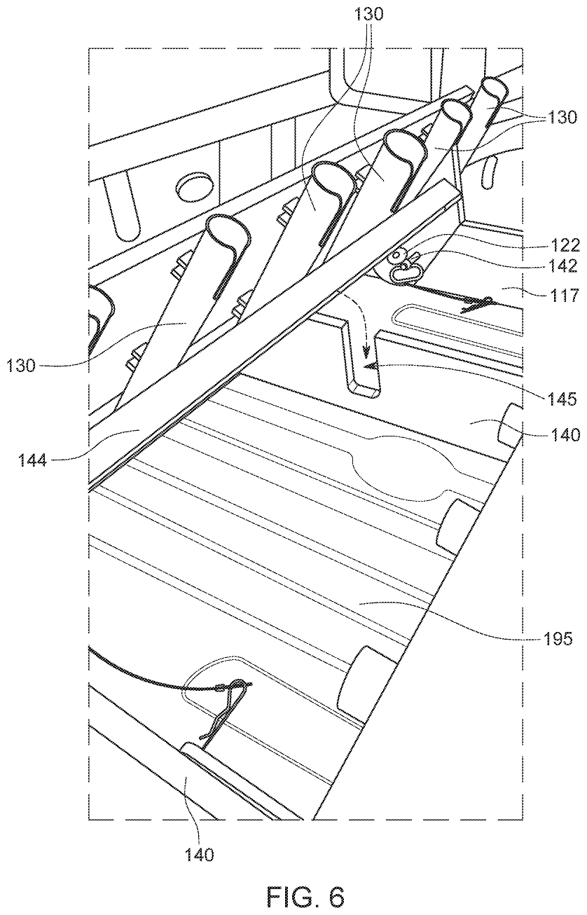

The main frame 110 has lateral members 111/113 and side members 117. The side members 117 include a least one hole 143 that aligns with at least one hole in an adjacent side member 117 for accepting a pin 142 for locking the movable frames 112/114 in the desired position. In embodiments having optional supports 144 (see FIG. 6) for the movable frames 112/114, an optional central support member 141 of the main frame 110 has notches 145 that accept the optional support 144 when the movable frames 112/114 are in the first position (e.g., relatively flat).

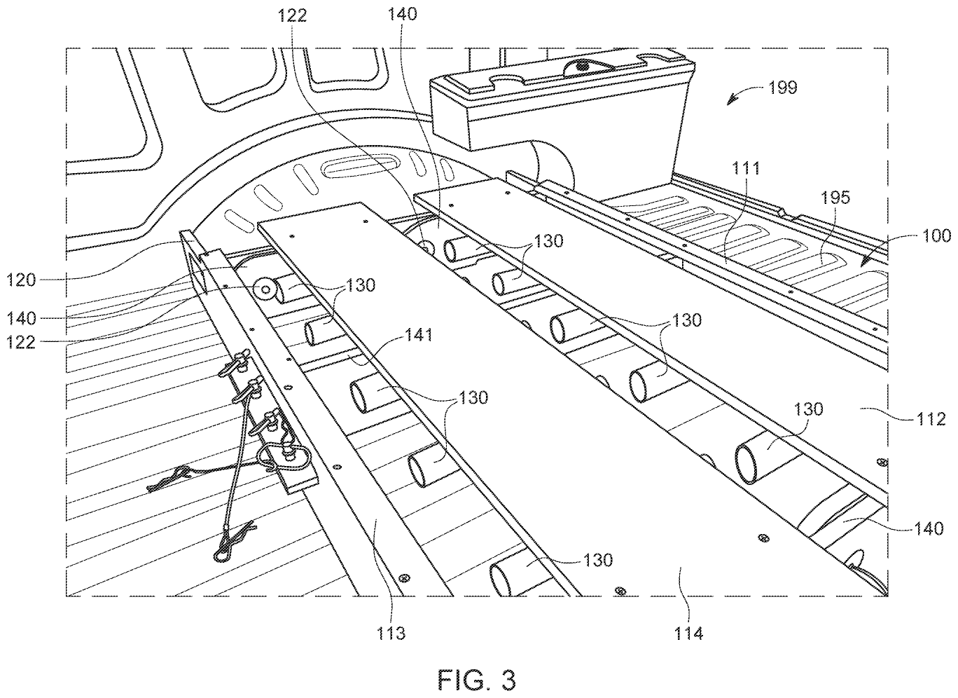

The lateral members 111/113 of the main frame 110 extend laterally beyond the side sections 140 by a distance 120 (see FIG. 3) that provides stability by straddling the wheel wells 197 of the truck bed 199. For example, by a distance of between 4 inches and 12 inches. In some embodiments, the lateral members 111/113 each have one or more cutouts 116 that are useful as handles for moving/carrying the fishing pole holder 100.

The lateral members 111/113 are spaced apart and extend sufficiently beyond the side members for straddling opposing wheel wells 197 of the truck bed 199, thereby reducing or eliminating any need to fasten the fishing pole holder 100 to the truck bed 199. By straddling the wheel wells 197, the fishing pole holder 100 installs/removes easily and quickly without fasteners or tools. In some embodiments tie-downs 118 are provided for extra security, for example, when storing the fishing pole holder 100.

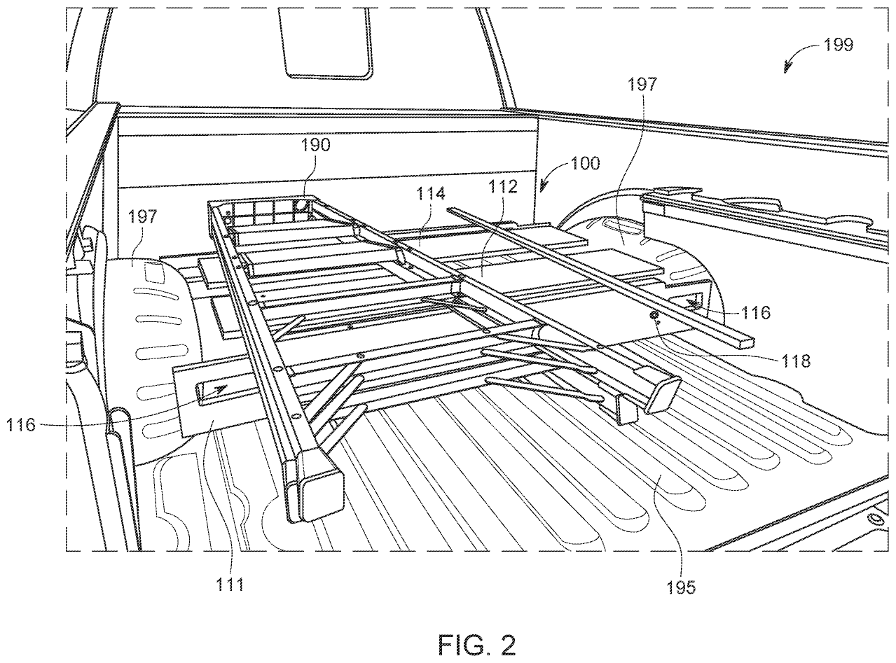

When in the first position (e.g., retracted), the fishing pole holder 100 is not holding any fishing poles 188 and is relatively flat with respect to the floor 195 of the truck bed 199, allowing for other objects to be carried upon the fishing pole holder 100, as for example, a ladder 190 as shown in FIG. 2.

In some embodiments, a shelf 182 is provided for storage of pins 142 and optional cotter pins 180.

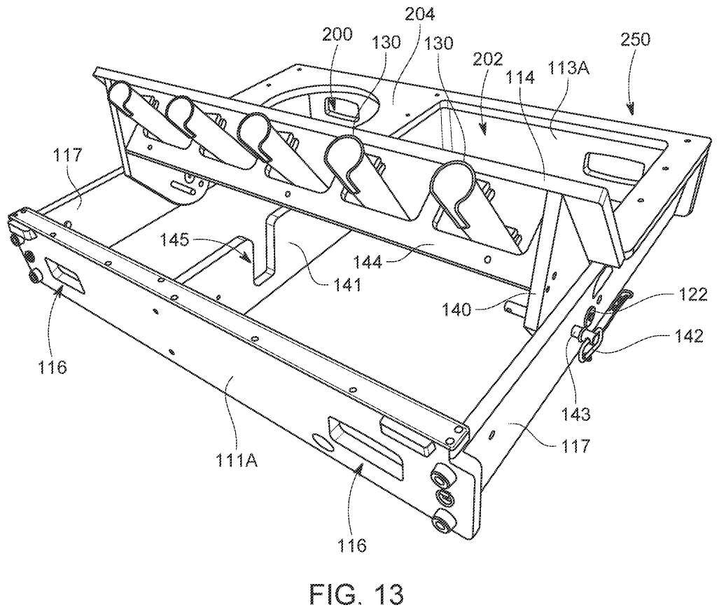

Referring to FIGS. 13-16, perspective views of a golf cart fishing pole holder 250 for a golf cart from various angles and sides are shown. The golf cart fishing pole holder 250 is shown external to the golf cart.

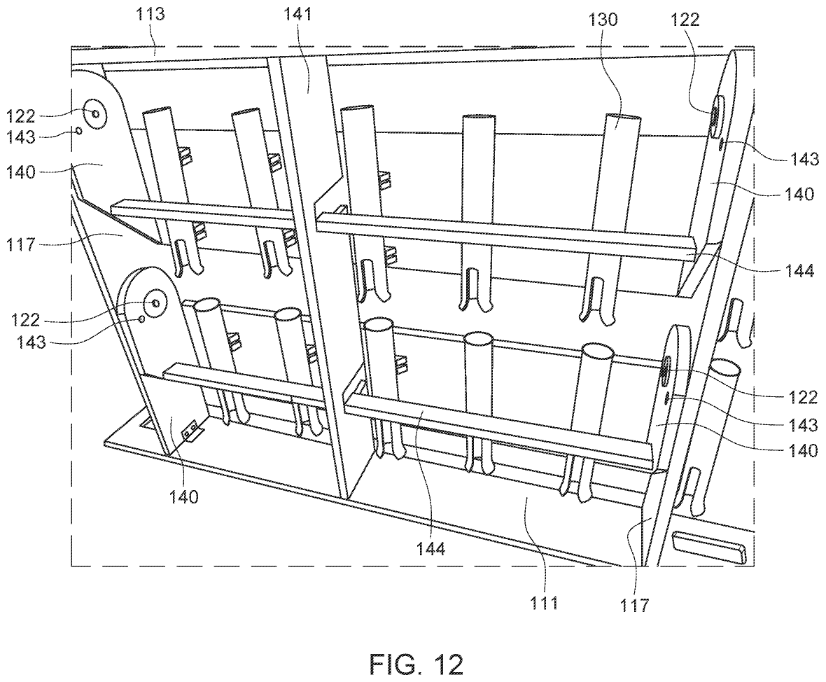

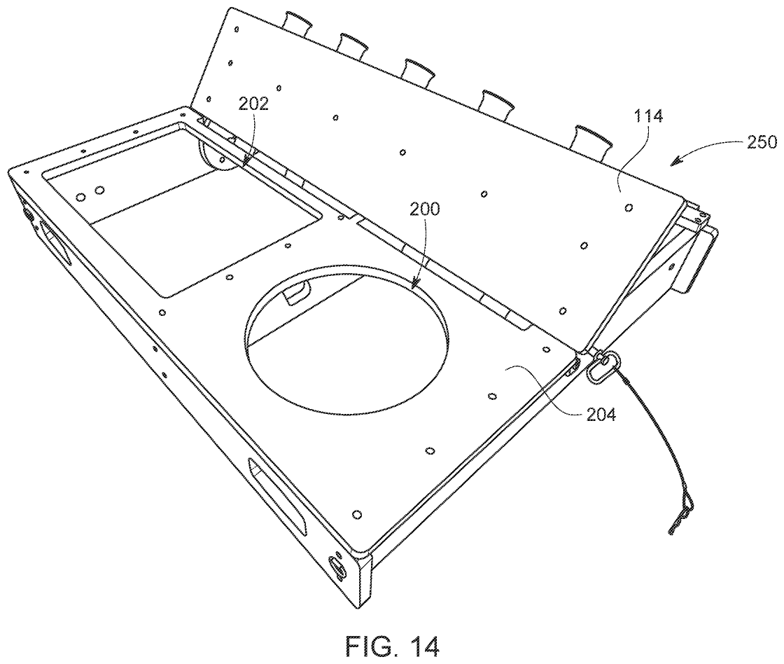

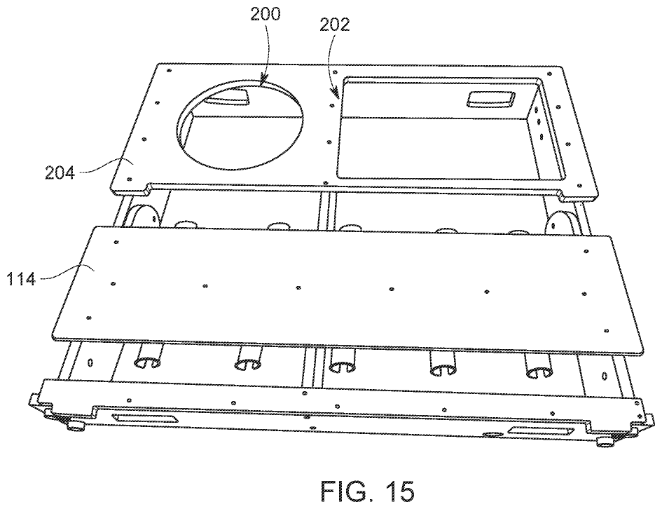

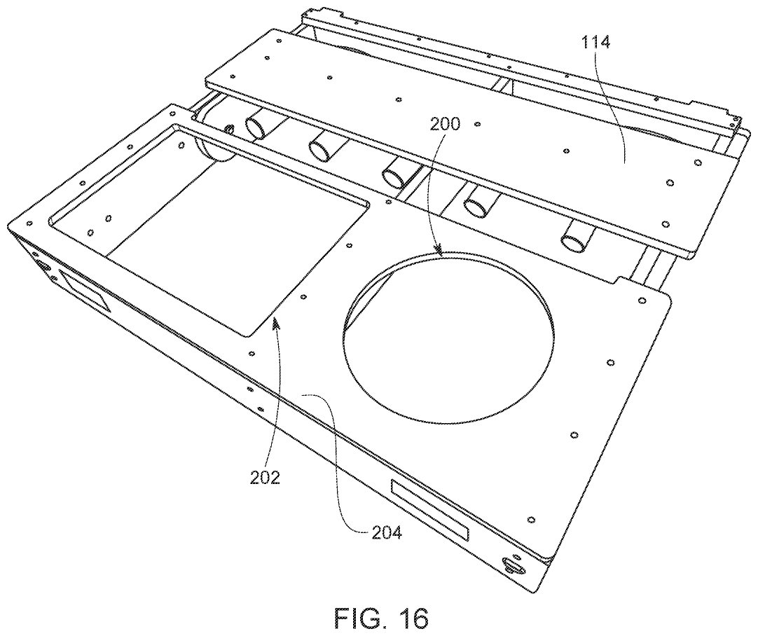

In the embodiment shown, there is one row of rod holders 130. The row of rod holders 130 is held by a first movable frame 114, though in an alternate embodiment, there is a second movable frame 114 with rod holders 130. Each movable frame 114 includes two side section 140 sections connected by a connecting member. The side sections 140 of the movable frame 114 are interfaced to the side members 117 of a main frame by pivots 122 such that the movable frame 114 has two positions that are independent of each other. In the first position, the respective movable frame 114 lays flat with respect to the side members 117 (e.g., approximately zero degrees) of the main frame (e.g., for storage) as shown in FIGS. 15 and 16. In the second position, the movable frame 114 extends upwardly at an angle with respect to the side members 117 of the main frame as shown in FIGS. 13 and 14, allowing for a fishing pole 188 to be inserted in any rod holder 130. A pin 142 is provided to pass through a hole 143 (see FIG. 12) that is bored through a side section 140 of the movable frame 114 and through a side member 117 of the main frame to hold/lock the movable frame 114 in the desired position with respect to the side member 117 of the main frame 110.

The main frame has lateral members 111A/113A and side members 117. The lateral members 111A/113A have lengths that are less than a width of the intended bed of a golf cart so as to fit on the bed of the golf cart. The side members 117 include at least one hole 143 that aligns with at least one hole in an adjacent side section 140 for accepting a pin 142 for locking the movable frames 114 in the desired position. In embodiments having optional supports 144 for the movable frames 114, an optional central support member 141 of the main frame has notches 145 that accept the optional support 144 when the movable frames 114 are in the first position (e.g., relatively flat).

In some embodiments, the lateral members 111A/113A of the main frame 110 extend laterally beyond the side members 117 but this is not required. In some embodiments, the lateral members 111A/113A each have one or more cutouts 116 that are useful as handles for moving/carrying the golf cart fishing pole holder 250.

When in the first position (e.g., retracted), the golf cart fishing pole holder 250 is not holding any fishing poles 188 and is relatively flat (e.g., approximately zero degrees) with respect to a floor of a golf cart or other surface on which the golf cart fishing pole holder 250 is placed, allowing for other objects to be carried upon the golf cart fishing pole holder 250, as for example, luggage or shopping bags.

In some embodiments, the golf cart fishing pole holder 250 has one row of movable frames 114 with several fishing pole holders 130 and instead of a second row of movable frames 114, the golf cart fishing pole holder 250 has a deck 204 that has storage cutouts 200/202 for accessories that are often transported to a location of fishing or other accessories. In the examples shown in FIGS. 13-16, two cutouts 200/202 are shown, a first cutout 200 is round for holding/retaining a bucket (not shown) and a second cutout 202 is rectangular (may have rounded corners) for holding/retaining a cooler or fishing tackle. Even when not used to go fishing, it is anticipated that the cutouts 200/202 help retain various accessories such as groceries that are often transported in golf carts. The cutouts 200/202 are cut out of or formed with the deck 204.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction, and arrangement of the components thereof without departing from the scope and spirit of the invention or without sacrificing all of its material advantages. The form herein before described being merely exemplary and explanatory embodiment thereof. It is the intention of the following claims to encompass and include such changes.

1. A golf cart fishing pole holder comprising:
a main frame having a front lateral member and a rear lateral member connected to each other by two side members, ends of each of the two side members connected to a respective front lateral member and a rear lateral member at substantially right angles, the front lateral member and the rear lateral member having a length that is shorter than a width of a bed of a golf cart;
a movable frame having two side sections and a connecting member connected between each of the two side sections, each of the two side sections is rotatably coupled to a respective one of the two side members;
a plurality of tubular rod holders affixed to the connecting member, each tubular rod holder of the plurality of tubular rod holders for accepting a fishing pole; and
whereas the movable frame is rotatable between a first position in which the tubular rod holders are within five degrees of being parallel to side members and a second position in which the tubular rod holders are at a non-zero angle with respect to the side members.

2. The golf cart fishing pole holder of claim 1, further comprising a deck affixed to a top surface of the rear lateral member and to top surfaces of each of the two side members.

3. The golf cart fishing pole holder of claim 2, wherein the deck comprises a circular aperture sized to accept and hold a bucket.

4. The golf cart fishing pole holder of claim 2, wherein the deck comprises a rectangular aperture sized to accept and hold an ice chest.

5. The golf cart fishing pole holder of claim 1, further comprising apertures formed in the front lateral member and the rear lateral member for carrying the golf cart fishing pole holder.

6. The golf cart fishing pole holder of claim 1, further comprising a hole passing through each of the two side sections and the two side members and the hole is sized to accept a locking pin and the locking pin is to be positioned in the hole when the movable frame is in the second position for locking the movable frame in the second position.

7. A method of holding fishing poles on a golf cart, the method comprising:
providing a fishing pole holder that has a main frame having a front lateral member and a rear lateral member connected to each other by two side members such that ends of each of the two side members connected a respective front lateral member and a rear lateral member at substantially right angles and the front lateral member and the rear lateral member sized to fit within a bed of the golf cart, the fishing pole holder also comprising a movable frame, the movable frame having two side sections and each side section is rotatably coupled to a respective one of the two side members; and
the movable frame has a plurality of tubular rod holders affixed thereto;
placing the fishing pole holder onto the bed of the golf cart;
rotating the movable frame to a position in which the tubular rod holders are at a non-zero angle with respect to the two side members; and
placing the fishing poles in any of the tubular rod holders.

8. The method of claim 7, further comprising inserting locking pins into holes passing through each of the two side sections and the two side members, the holes are sized to accept the locking pins, thereby locking the movable frame to the position in which the tubular rod holders are at the non-zero angle with respect to the two side members.

9. The method of claim 7, wherein the fishing pole holder further comprises apertures formed in the front lateral member and the rear lateral member and carrying the fishing pole holder by placing fingers through the apertures.

10. The method of claim 7, wherein the fishing pole holder further comprises a deck affixed to a top surface of the rear lateral member and to top surfaces of each of the two side members.

11. The method of claim 10, wherein the deck comprises a circular aperture sized to accept and hold a bucket and the method further comprises inserting the bucket into the circular aperture for holding the bucket.

12. The method of claim 10, wherein the deck comprises a rectangular aperture sized to accept and hold an ice chest and the method further comprises inserting the ice chest into the rectangular aperture for holding the ice chest.

13. An apparatus for holding fishing poles comprising:
a main frame has a front lateral member and a rear lateral member connected to each other by two side members, ends of each of the two side members are connected respectively to a front lateral member and a rear lateral member at substantially right angles, the front lateral member and the rear lateral member sized to fit within a bed of a golf cart;
a movable frame, the movable frame having two side sections connected by a connecting member and each side section is rotatably coupled to a respective one of the two side members by a pivot;
a plurality of tubular rod holders, each tubular rod holder of the plurality of tubular rod holders is affixed to a surface of the connecting member, each tubular rod holder for accepting a fishing pole;
whereas the movable frame is rotatable about each pivot between a first position in which the tubular rod holders are within five degrees of being parallel to the two side members and a second position in which the tubular rod holders are at a non-zero angle with respect to the two side members; and
a hole passes through each of the two side sections and each of the two side members and the hole is sized to accept a locking pin.

14. The apparatus for holding the fishing poles of claim 13, further comprising apertures formed in the front lateral member and the rear lateral member for carrying the apparatus for holding the fishing poles.

15. The apparatus for holding the fishing poles of claim 14, further comprising the locking pin inserted into the hole when the movable frame is in the second position for locking the movable frame in the second position.

16. The apparatus for holding the fishing poles of claim 13, further comprising a support running parallel with the two side members, one end of the support connected to the front lateral member and an opposing second end connected to the rear lateral member.

17. The apparatus for holding the fishing poles of claim 13, further comprising a deck affixed to a top surface of the rear lateral member and to top surfaces of each of the two side members.

18. The apparatus for holding the fishing poles of claim 17, wherein the deck comprises a circular aperture sized to accept and hold a bucket.

19. The apparatus for holding the fishing poles of claim 17, wherein the deck comprises a rectangular aperture sized to accept and hold an ice chest.
